(19) United States
(12) Patent Application Publication
(10) Pub. No.: US 2020/0248315 A1
(43) Pub. Date: Aug. 6, 2020

(54) LASER CLAD LAYER FORMING METHOD AND LASER CLADDING DEVICE

(71) Applicant: JTEKT CORPORATION, Osaka-shi (JP)

(72) Inventors: Fumiki OGAWA, Kariya-shi (JP); Takuya KITO, Toyota-shi (JP); Junichi SUZUKI, Nishio-shi (JP)

(73) Assignee: JTEKT CORPORATION, Osaka-shi (JP)

(21) Appl. No.: 16/777,419

(22) Filed: Jan. 30, 2020

(30) Foreign Application Priority Data
Feb. 4, 2019 (JP) 2019-018299
Feb. 14, 2019 (JP) 2019-024344

(51) Int. Cl. C23C 24/10; B23K 26/144; B23K 26/354

(52) U.S. Cl. CPC C23C 24/103; B23K 26/354; B23K 26/144

(57) ABSTRACT

A laser clad layer forming method includes a partitioning process of partitioning a formation-scheduled portion for a laser clad layer on a peripheral surface of a workpiece into areas; a phase determining process of holding the workpiece such that an axial direction thereof is horizontal and determining a phase of the workpiece such that a direction of a normal to the peripheral surface of the workpiece in one area is within a predetermined angle range with respect to a vertical upward direction; and a forming process of irradiating a powder with a laser beam while supplying the powder to the one area in a state in which the phase of the workpiece is determined and melting the powder to form a bead. The laser clad layer is formed by repeating the phase determining process and the forming process on the areas to form the beads in the whole formation-scheduled portion.

### CROSS-REFERENCE TO RELATED APPLICATIONS

This application claims priority to Japanese Patent Application No. 2019-018299 filed on Feb. 4, 2019 and Japanese Patent Application No. 2019-024344 filed on Feb. 14, 2019, each incorporated herein by reference in its entirety.

### BACKGROUND

### 1. Technical Field

The disclosure relates to a laser clad layer forming method and a laser cladding device.

### 2. Description of Related Art

There has been a method of forming a coating of a white metal which is a tin-based alloy on an inner peripheral portion of a bearing metal workpiece by powder plasma spraying for the purpose of improvement in seizure resistance of the bearing metal that supports a shaft of a grinding machine or the like such that the shaft is rotatable (for example, see Japanese Patent Application Publication No. 2001-335914 (JP 2001-335914 A) and Japanese Patent Application Publication No. 2008-190656 (JP 2008-190656 A)).

In the related art, since a spraying density is low, a spraying thickness which is several times larger than a finishing thickness is required and a large number of man-hours are required for stacking several tens of layers, and a material yield is also low. Since a strength of adhesion of a material to a workpiece is low in powder plasma spraying, it is necessary to perform a pretreatment such as flux coating or shot blasting on a workpiece.

There has been a laser cladding method as another method of forming a coating of a metal (for example, see Japanese Patent Application Publication No. 9-66379 (JP 9-66379 A) or the like). According to a laser cladding method, there is an advantage that it is possible to efficiently form a coating of a metal with a high density (a laser clad layer).

### SUMMARY

However, in a case where a laser clad layer of a metal with a low melting point (for example, a metal or an alloy with a melting point of 500° C. or lower) such as a white metal is formed on a peripheral surface of a workpiece around a central axis thereof, much time is required for the solidification thereof due to its low melting point, and sagging of beads occurs when a workpiece heated by irradiation with a laser beam becomes inclined. This may easily cause deterioration of quality.

The disclosure provides a laser clad layer forming method and a laser cladding device that can efficiently form a laser clad layer of a metal with a melting point of 500° C. or lower while preventing occurrence of sagging of a bead.

A first aspect of the disclosure relates to a laser clad layer forming method of irradiating a powder of a metal with a melting point of 500° C. or lower with a laser beam from a laser irradiation unit while supplying the powder to a peripheral surface of a workpiece around a central axis of the workpiece and forming a laser clad layer of the metal on the peripheral surface of the workpiece using the powder that is molten.

The laser clad layer forming method according to the above-mentioned aspect includes a partitioning process of partitioning a formation-scheduled portion for the laser clad layer on the peripheral surface of the workpiece into a plurality of areas each of which has an angle equal to or less than 90 degrees in a circumferential direction; a phase determining process of holding the workpiece such that an axial direction thereof is horizontal and determining a phase of the workpiece such that a direction of a normal to the peripheral surface of the workpiece in one area of the plurality of areas is within a predetermined angle range with respect to a vertical upward direction; and a forming process of irradiating the powder with the laser beam while supplying the powder to the one area in a state in which the phase of the workpiece is determined and melting the powder to form a bead. The laser clad layer is formed by repeating the phase determining process and the forming process on the areas to form the beads in the whole formation-scheduled portion.

According to this method, by repeating determination of a phase for placing one area on the peripheral surface of the workpiece in an almost horizontal state, and forming of the beads by irradiating the powder of the metal with the melting point of 500° C. or lower with the laser beam in the one area, it is possible to efficiently form the laser clad layer while preventing sagging of the beads.

A second aspect of the disclosure relates to a laser cladding device including a laser irradiation unit configured to irradiate a powder of a metal with a melting point of 500° C. or lower with a laser beam while supplying the powder to a workpiece; a rotating mechanism configured to rotate the workpiece around a central axis of the workpiece while holding the workpiece such that an axial direction thereof is horizontal; a moving mechanism configured to move the laser irradiation unit and the workpiece relative to each other in the axial direction; and a control unit configured to perform control for repeatedly performing i) an operation of determining a phase of the workpiece such that a direction of a normal to a peripheral surface of the workpiece in one area among a plurality of areas is within a predetermined angle range with respect to a vertical upward direction, a formation-scheduled portion for a laser clad layer on the peripheral surface of the workpiece being partitioned into the plurality of areas, and each of the plurality of areas having an angle equal to or less than 90 degrees in a circumferential direction, and ii) an operation of irradiating the powder with the laser beam while supplying the powder to the one area from the laser irradiation unit and melting the powder to form a bead in a state in which the phase of the workpiece is determined, using the laser irradiation unit and the moving mechanism.

With this configuration, by repeating determination of a phase for placing one area on the peripheral surface of the workpiece in an almost horizontal state and forming of the beads by irradiating the powder of the metal with the melting point of 500° C. or lower with the laser beam in the one area, it is possible to efficiently form the laser clad layer while preventing sagging of the beads.

A third aspect of the disclosure relates to a laser clad layer forming method of irradiating a powder of a metal with a melting point of 500° C. or lower with a laser beam from a laser irradiation unit while supplying the powder to a peripheral surface of a workpiece around a central axis of the workpiece and forming a laser clad layer of the metal on the peripheral surface of the workpiece using the powder that is molten.

The laser clad layer forming method according to the third aspect of the disclosure includes a forming process of irradiating the powder with the laser beam while supplying the powder to a formation-scheduled portion for the laser clad layer on the peripheral surface of the workpiece and melting the powder to form a bead; and a control process of controlling a size of a molten pool which is formed due to irradiation with the laser beam during the forming process.

According to this method, by forming the beads while controlling the size of the molten pool of the metal which is formed due to irradiation with the laser beam, it is possible to efficiently form the laser clad layer while preventing sagging of the beads due to enlargement of the molten pool.

A fourth aspect of the disclosure relates to a laser cladding device including a laser torch configured to irradiate a powder of a metal with a melting point of 500° C. or lower with a laser beam while supplying the powder to a workpiece; a moving mechanism configured to move the laser torch and the workpiece relative to each other; and a control unit configured to irradiate a formation-scheduled portion for a laser clad layer on a peripheral surface of the workpiece around a central axis of the workpiece with the laser beam via the laser torch so as to melt the powder to form a bead, while moving the laser torch and the workpiece relative to each other via the moving mechanism and supplying the powder from the laser torch, and to control a size of a molten pool which is formed due to irradiation with the laser beam during forming of the bead.

With this configuration, by irradiating the powder with the laser beam while moving the laser irradiation unit and the workpiece relative to each other via the moving mechanism and supplying the powder from the laser irradiation unit, melting the powder to form the bead, and causing the control unit to control the size of the molten pool which is formed due to irradiation with the laser beam during the forming of the bead, it is possible to efficiently form the laser clad layer while preventing sagging of the bead due to enlargement of the molten pool.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an entire configuration diagram illustrating a configuration of a laser cladding device and a positional relationship with a workpiece according to a first embodiment;

FIG. 2 is an enlarged side view of a distal end of a laser torch of the laser cladding device according to the first embodiment;

FIG. 3 is a flowchart illustrating the entire flow of a laser clad layer forming method according to the first embodiment;

FIG. 4 is a perspective view schematically illustrating an example in which beads are formed on an inner peripheral surface of a workpiece according to the first embodiment;

FIG. 5 is a perspective view schematically illustrating an example in which beads are formed on an inner peripheral surface of a workpiece according to a modified example of the first embodiment;

FIG. 6 is an entire configuration diagram illustrating a configuration of a laser cladding device and a positional relationship with a workpiece according to a second embodiment;

FIG. 7 is a perspective view schematically illustrating an example in which beads are formed on an outer peripheral surface of a workpiece according to the second embodiment;

FIG. 8 is an entire configuration diagram illustrating a configuration of a laser cladding device and a positional relationship with a workpiece according to another modified example;

FIG. 9 is an entire configuration diagram illustrating a configuration of a laser cladding device and a positional relationship with a workpiece according to a third embodiment;

FIG. 10 is an enlarged side view of a distal end of a laser torch of the laser cladding device according to the third embodiment;

FIG. 11 is a flowchart illustrating the entire flow of a laser clad layer forming method according to the third embodiment;

FIG. 12 is a perspective view schematically illustrating an example in which a bead is formed on an inner peripheral surface of a workpiece according to the third embodiment;

FIG. 13 is a perspective view illustrating a bead forming path on the inner peripheral surface of the workpiece according to the third embodiment;

FIG. 14 is an entire configuration diagram illustrating a configuration of a laser cladding device and a positional relationship with a workpiece according to a fourth embodiment;

FIG. 15 is a perspective view schematically illustrating an example in which a bead is formed on an outer peripheral surface of a workpiece according to the fourth embodiment;

FIG. 16 is a perspective view illustrating a bead forming path on the outer peripheral surface of the workpiece according to the fourth embodiment;

FIG. 17 is an entire configuration diagram illustrating a configuration of a laser cladding device and a positional relationship with a workpiece according to a fifth embodiment;

FIG. 18 is a flowchart illustrating the entire flow of a laser clad layer forming method according to the fifth embodiment; and

FIG. 19 is a perspective view illustrating a bead forming path on an inner peripheral surface of a workpiece according to a modified example.

### DETAILED DESCRIPTION OF EMBODIMENTS

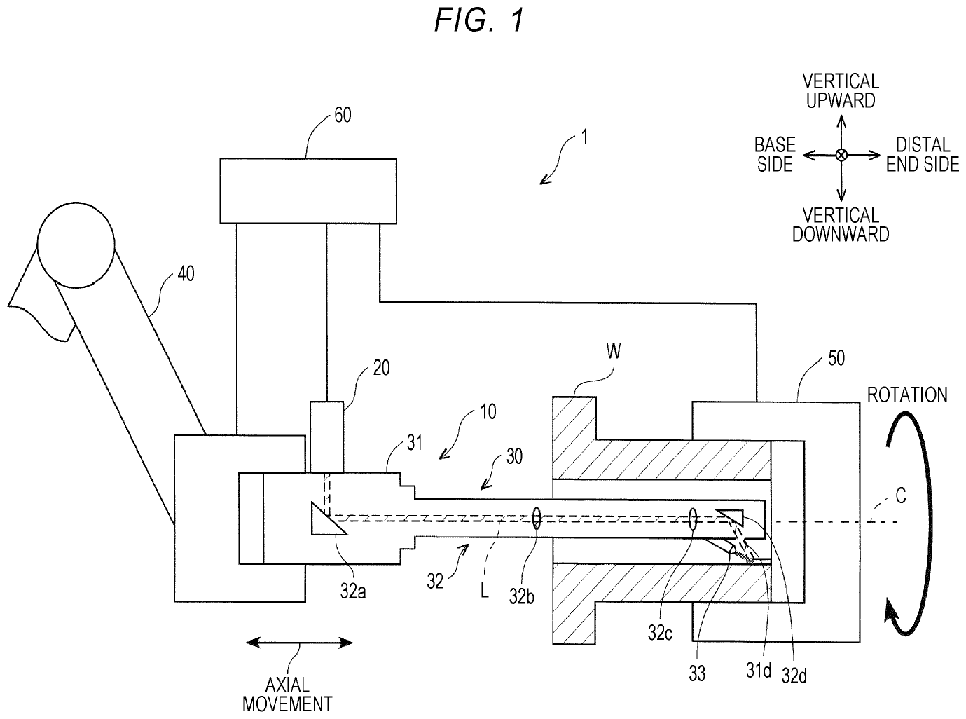

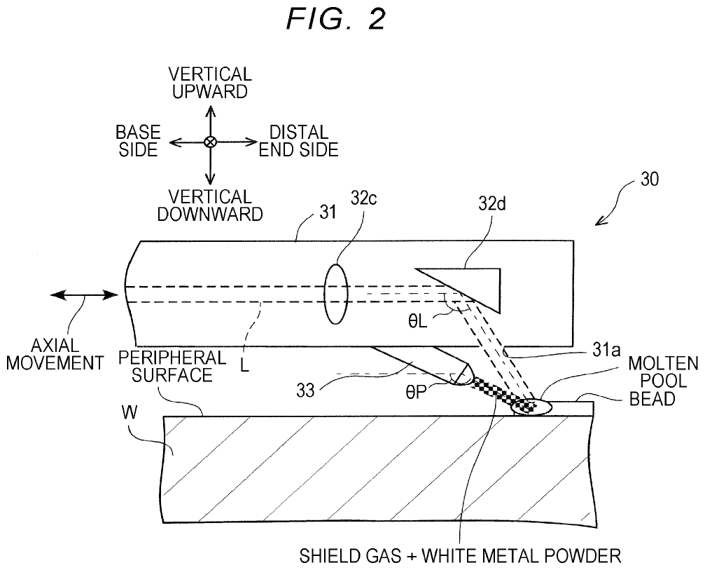

Hereinafter, laser clad layer forming methods and laser cladding devices according to embodiments of the disclosure will be described with reference to the accompanying drawings. A configuration of a laser cladding device 1 according to a first embodiment will be described below with reference to FIG. 1. FIG. 1 is an entire configuration diagram illustrating a configuration of the laser cladding device 1 and a positional relationship with a workpiece W according to the first embodiment. FIG. 2 is an enlarged side view of a distal end of a laser torch 30 of the laser cladding device 1.

The laser cladding device 1 is a device that forms a laser clad layer of a metal with a melting point of 500° C. or lower on a peripheral surface of a workpiece (in other words, a base material) W. In this embodiment, it is assumed that a laser clad layer is made of a tin-based metal as the metal with a melting point of 500° C. or lower. Examples of the tin-based metal include tin (Sn) and tin alloys containing tin as a major component. Examples of the tin alloy include alloys containing metals such as copper (Cu), lead (Pb), zinc (Zn), silver (Ag), and bismuth along with tin, as components. In this embodiment, it is assumed that a white metal is used as an example of the tin-based metal. The white metal is a tin-based alloy described in JIS5401 and is an alloy containing antimony, copper, or the like with tin as a major component. The workpiece W is a cylindrical member and includes a radial inner portion W1. In this embodiment, an example of the workpiece W is a bearing metal that is made of an iron-based metal material such as a chromium-molybdenum steel, and that supports a shaft of a grinding machine or the like such that the shaft is rotatable. Here, the workpiece W is not limited to a bearing metal.

As illustrated in FIG. 1, the laser cladding device 1 includes a laser beam irradiation mechanism 10, a rotating mechanism 50, and a control unit 60. The laser beam irradiation mechanism 10 includes a laser oscillator 20, a laser torch 30, and a moving mechanism 40.

The laser oscillator 20 is attached to an outer peripheral surface of a base side of the laser torch 30 and emits a laser beam L inward in a radial direction of the laser torch 30. In this embodiment, an output power of the laser beam is set to be constant, but the output power of the laser beam may be set to be variable by controlling the laser oscillator 20. The laser torch 30 constitutes a laser irradiation unit of the disclosure and includes a cylindrical body 31, an optical system 32 that is disposed inside the body 31, and a powder supply unit 33. An exit port 31a is formed on a lower side surface in the vicinity of a distal end of the body 31.

The optical system 32 includes a first reflecting portion 32a, a first focusing portion 32b, a second focusing portion 32c, and a second reflecting portion 32d. The first reflecting portion 32a is disposed inside the base side of the laser torch 30 and reflects a laser beam L emitted from the laser oscillator 20 in a radial direction toward the distal end in the axial direction. The first focusing portion 32b and the second focusing portion 32c are convex lenses for focusing a laser beam, are arranged sequentially along an optical axis of the laser beam L reflected by the first reflecting portion 32a inside the body 31, and serve to focus a laser beam L and to guide the laser beam L to the second reflecting portion 32d.

The second reflecting portion 32d is disposed inside the vicinity of the distal end of the body 31 facing the exit port 31a and reflects the laser beam L, which is focused by the first focusing portion 32b and the second focusing portion 32c, obliquely downward. For example, as illustrated in FIG. 2, the laser beam L which is incident on the second reflecting portion 32d is reflected downward at an angle θL with respect to the axial direction of the body 31 and is applied to a workpiece W via the exit port 31a. The angle θL may be set to, for example 120°.

The powder supply unit 33 is disposed in the vicinity of the base side of the exit port 31a and supplies a powder of a white metal to a laser-beam irradiation surface of the workpiece W with blowing of an inert shield gas. The particle size of the powder of the white metal which is used herein ranges, for example, from about 50 μm to 100 μm. For example, as illustrated in FIG. 2, the powder supply unit 33 supplies the powder of a white metal in a downward direction at an angle θP with respect to the axial direction of the body 31. The angle θP may be set to, for example 150°.

The moving mechanism 40 is a mechanism that moves the laser torch 30 and the workpiece W relative to each other in the axial direction. The moving mechanism 40 may be a known mechanism that can hold and horizontally move the laser torch 30 in the axial direction, for example, a robot arm.

The rotating mechanism 50 is a mechanism that holds the workpiece W such that the axial direction thereof is horizontal and rotates the workpiece W around the axis C. The rotating mechanism 50 includes, for example, a chuck that holds an axial end of the workpiece W and a servomotor that rotates the chuck around the central axis C.

The control unit 60 is a computer including a CPU, a ROM, and a RAM which are not illustrated, and performs processes of the laser clad layer forming method by controlling the operations of the units of a laser beam irradiation mechanism 10 and the rotating mechanism 50.

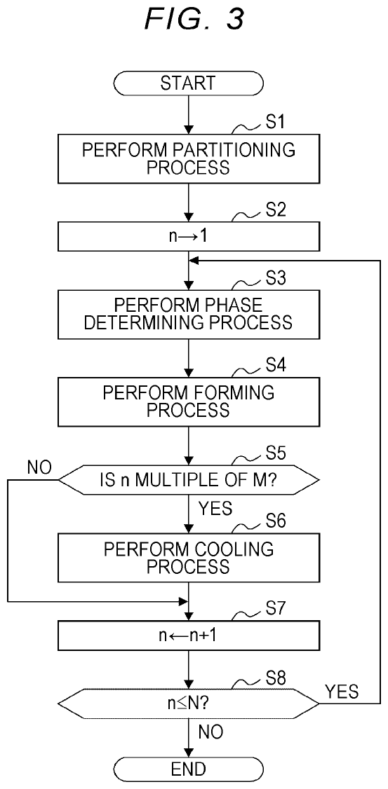

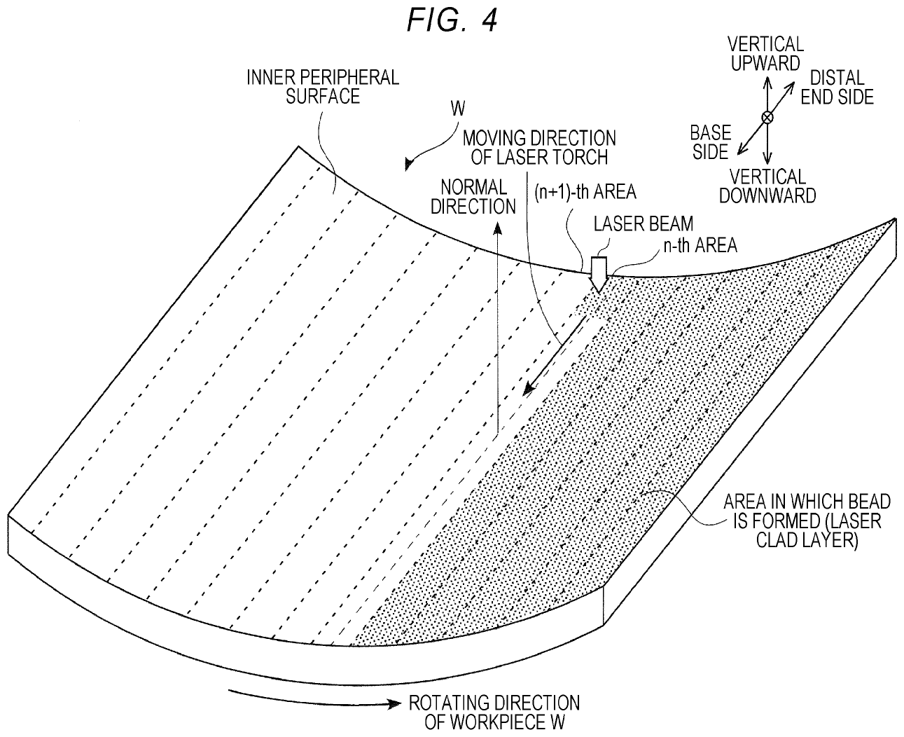

A laser clad layer forming method using the laser cladding device 1 will be described below with reference to FIGS. 3 and 4. FIG. 3 is a flowchart illustrating the flow of the laser clad layer forming method. FIG. 4 is a perspective view schematically illustrating an example in which the method of forming a laser clad layer is applied to an inner peripheral surface of a workpiece W, and illustrating a part of the workpiece W. The laser clad layer forming method according to this embodiment is a method of irradiating an inner peripheral surface of the workpiece W around the central axis C with a laser beam while supplying a powder of a white metal which is a metal with a melting point of 500° C. or lower via the laser torch 30 and forming a laser clad layer of the white metal on the inner peripheral surface of the workpiece W using the molten powder. The laser clad layer forming method is performed by the control unit 60.

First, as illustrated in the flowchart of FIG. 3, a partitioning process is performed in Step 1 (Step 1 is hereinafter abbreviated to S1. The same applies to the subsequent steps). The partitioning process S1 is a process of partitioning a formation-scheduled portion for a laser clad layer (i.e., a portion on which a laser clad layer is to be formed) on the peripheral surface of the workpiece W into a plurality of areas each of which has an angle equal to or less than 90 degrees in the circumferential direction. In this embodiment, the entire inner peripheral surface of the workpiece W is used as the formation-scheduled portion, and is partitioned into N areas (where N is a positive integer) in the circumferential direction. Each of the N areas corresponds to a bead width of the white metal which is formed by the laser cladding device 1. The bead width is about several mm (for example, 5 mm). The process of defining the areas is performed as an internal process performed in the control unit 60, but boundaries between the neighboring areas are illustrated by dashed lines in FIG. 4 for the purpose of easy understanding. Subsequent to the partitioning process S1, a variable n is set to 1 in S2.

Then, in S3, a phase determining process is performed. The phase determining process S3 is a process of holding the workpiece W such that the axial direction thereof is horizontal and determining the phase of the workpiece W such that a direction of a normal to the peripheral surface of the workpiece W in one area of the plurality of areas defined in the partitioning process S1 is within a predetermined angle range with respect to the vertical upward direction. In this embodiment, the workpiece W is held by the rotating mechanism 50 such that the axial direction thereof is horizontal and the phase is determined by rotating the workpiece W such that the direction of the normal to the inner peripheral surface of the workpiece W at the center, in the circumferential direction, of the n-th area (where n is an integer in a range of 1 to N) in which a bead (i.e., a weld bead) is not formed among the N areas is the vertical upward direction. In FIG. 4, the center, in the circumferential direction, of the n-th area is illustrated by an alternative long and short dash line.

In the state illustrated in FIG. 4, the center of the n-th area in the circumferential direction is located on the lowermost side in the vertical direction on the inner peripheral surface of the workpiece W. That is, in each phase determining process S3, the workpiece W is rotated by an angle corresponding to the length of each area in the circumferential direction and the phase is determined such that the n-th area in which a bead is to be formed is located on the lowermost side in the vertical direction.

Then, in S4, a forming process is performed. The forming process S4 is a process of irradiating one area with a laser beam while supplying a powder of a white metal to the one area in a state in which the phase of the workpiece W is determined and melting the powder to form a bead. In this embodiment, in a state in which the phase of the workpiece W is determined by the rotating mechanism 50, the laser torch 30 is moved to a position at which a first end of the workpiece W in the axial direction can be irradiated with a laser beam, by the moving mechanism 40. Subsequently, the n-th area which is located immediately below the laser torch 30 is irradiated with a laser beam while a powder of a white metal is supplied to the n-th area from the powder supply unit 33, and the powder is molten to form the bead. Specifically, a powder is molten to form the bead by forming a molten pool in the workpiece W irradiated with a laser beam and supplying the powder to the molten pool or by irradiating the powder with the laser beam. At the same time, the laser torch 30 is relatively moved to a second end of the workpiece W in the axial direction by the moving mechanism 40.

In FIG. 4, an example in which the laser torch 30 is moved from a distal end to a base in the axial direction to form a bead in the n-th area is illustrated. In FIG. 4, a part in which beads are formed on the inner peripheral surface of the workpiece W is illustrated with meshes. Thus, the bead of a white metal extending in an axially straight shape is formed in the n-th area on the inner peripheral surface of the workpiece W. Since the bead is formed in a state in which rotation of the workpiece W is stopped and the n-th area is held in an almost horizontal state, it is possible to curb occurrence of sagging.

In a method using plasma spraying in the related art, since the thickness of a white metal which is formed by one time of spraying is small, stacking of about 80 layers is required for realizing a build-up thickness of 1.5 mm to 2 mm. However, in this embodiment, since the thickness of the bead, which is formed by moving the laser torch 30 one time, ranges 1.5 mm to 2 mm, the necessary build-up thickness can be realized by one layer. In comparison with build-up using plasma spraying, in the embodiment using a laser clad layer, a strength of adhesion of the laser clad layer to the workpiece is high and pretreatment such as flux coating or shot blasting is not required.

Then, in S5, it is determined whether n is a multiple of M. Here, M is an integer equal to or greater than 1 and equal to or less than N and is set to, for example, a value corresponding to a rotational phase of 30° to 50° of the workpiece W. When n is not a multiple of M (S5: NO), the flow progresses to S7. On the other hand, when n is a multiple of M (S5: YES), a cooling process is performed in S6. In the cooling process S6, rotation of the workpiece W by the rotating mechanism 50 and forming of the bead by the laser beam irradiation mechanism 10 are stopped and the flow waits for a predetermined time at the ordinary temperature. That is, after the phase determining process S3 and the forming process S4 are repeated M times, the cooling process is performed for a predetermined time and then the phase determining process S3 and the forming process S4 are repeated M times. For example, M may be set to a value corresponding to a rotational phase of 40° of the workpiece W, and the cooling process during 5 minutes may be performed 9 times while the beads are formed on the entire inner peripheral surface (360°) of the workpiece W. The reason why the cooling process S6 is performed in this way is that sagging of beads is likely to occur when the workpiece W is gradually heated by continuous forming of beads. By lowering the temperature of the workpiece W through the cooling process S6 once and then restarting the forming of the bead, it is possible to more effectively prevent occurrence of sagging.

Then, in S7, the variable n is increased by 1. Subsequently, in S8, it is determined whether n≤N is satisfied. The flow returns to S3 when n≤N is satisfied (S8: YES), and the flow ends when n>N is satisfied (S8: NO). That is, a laser clad layer is formed by repeatedly performing the phase determining process S3 and the forming process S4 on the first to N-th areas to form beads in the entire formation-scheduled portion on the inner peripheral surface of the workpiece W.

As described above, with the laser cladding device 1 according to this embodiment, it is possible to reliably perform a laser clad layer forming method that makes it possible to efficiently form a laser clad layer while preventing sagging of beads, by repeatedly performing the phase determining process S3 of determining the phase of the workpiece W such that one area on the peripheral surface thereof is in an almost horizontal state and the forming process S4 of irradiating a powder of a metal with a laser beam in the one area to form the bead.

By determining a phase of a next area and forming the bead in the next area after cooling and solidifying the beads in the cooling process S6, it is possible to more reliably prevent sagging of beads. Particularly, beads can be efficiently formed by repeatedly performing the phase determining process S3 and the forming process S4 a plurality of times, and sagging of beads which is likely to occur by inclining the heated workpiece W can be more reliably prevented by cooling and solidifying the beads in the cooling process S6.

Particularly, in this embodiment, by inserting and disposing the laser torch 30 in a space defined by the inner periphery of a workpiece W and repeatedly performing determination of a phase with rotation of the workpiece W and movement in the axial direction of the laser torch 30, it is possible to efficiently form a laser clad layer on the entire inner peripheral surface of the workpiece W while preventing sagging of beads.

In this embodiment, the partitioning process S1 includes partitioning a formation-scheduled portion for a laser clad layer into a plurality of areas each of which corresponds to a width of a bead, the phase determining process S3 includes determining the phase of the workpiece W by rotating the workpiece W by a phase angle corresponding to the width of bead, and the forming process S4 includes forming a bead in an axially straight shape on the inner peripheral surface of the workpiece W by moving the workpiece W and the laser torch 30 relatively to each other in the axial direction. Accordingly, it is possible to form a laser clad layer on the entire inner peripheral surface of the workpiece W by repeating rotation of the workpiece W and moving the laser torch 30 in the axial direction.

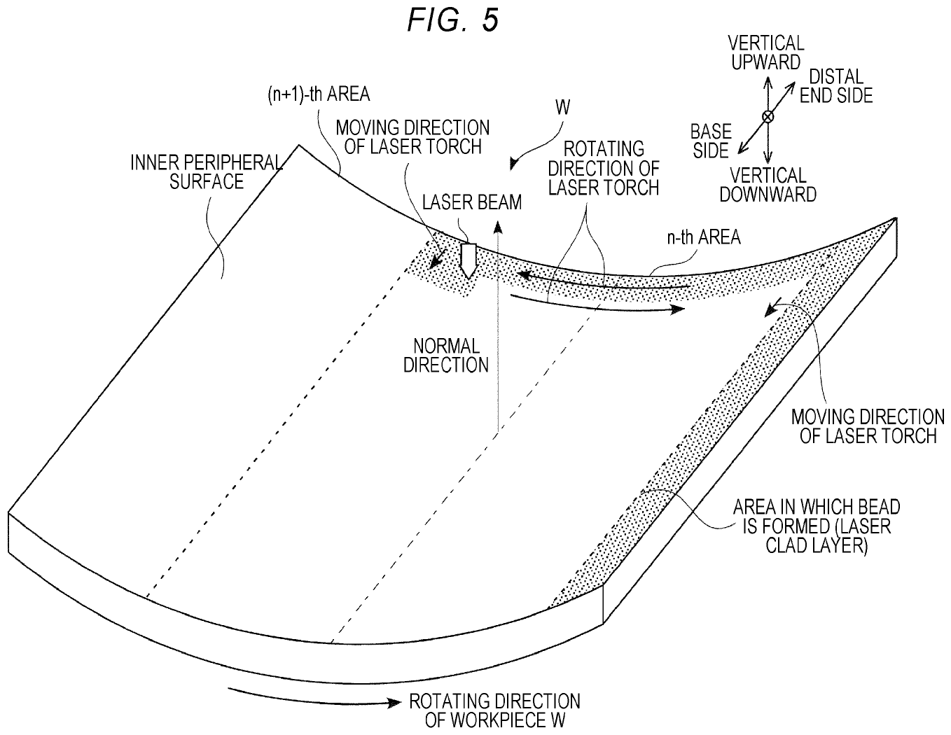

A modified example of the first embodiment will be described below with reference to FIG. 5. FIG. 5 is a perspective view schematically illustrating an example in which beads are formed on an inner peripheral surface of a workpiece W according to the modified example. In the above-mentioned embodiment, an inner peripheral surface of a workpiece W is partitioned into a plurality of areas in the circumferential direction such that each of the plurality of areas corresponds to a bead width, and a bead is formed in an axially straight shape in each area. However, in this modified example, an inner peripheral surface of a workpiece W is partitioned into a plurality of areas with a predetermined angle in the circumferential direction and a bead is formed in a rectangular wave shape by repeating rotation of the laser torch 30 in the circumferential direction and movement thereof in the axial direction in each area. Arrangement of the laser torch 30 relative to the workpiece W is the same as illustrated in FIG. 1, as well as in the above-mentioned embodiment.

In the partitioning process S1, as illustrated in FIG. 5, a formation-scheduled portion for a laser clad layer on an inner peripheral surface of a workpiece W is partitioned into N areas (where N is a positive integer) from first to N-th areas such that each of N areas has a predetermined angle equal to or less than 90 degrees in the circumferential direction. For example, when the entire inner peripheral surface (360 degrees) of the workpiece W in the circumferential direction is partitioned into areas at intervals of 20 degrees in the circumferential direction, the inner peripheral surface of the workpiece W is partitioned into 18 areas from the first to eighteenth areas.

In the phase determining process S3, the workpiece W is held such that the axial direction thereof is horizontal by the rotating mechanism 50 and the phase is determined by rotating the workpiece W such that the direction of the normal to the inner peripheral surface of the workpiece W at the center, in the circumferential direction, of the n-th area (where n is an integer in a rage of 1 to N) in which a bead is not formed among the N areas is the vertical upward direction. In this state, the center of the n-th area in the circumferential direction is located on the lowermost side in the vertical direction on the inner peripheral surface of the workpiece W. That is, in each phase determining process S3, the workpiece W is rotated by an angle corresponding to the length of each area in the circumferential direction and the phase is determined such that the n-th area in which a bead is to be formed is located on the lowermost side in the vertical direction.

In the forming process S4, in a state in which the phase of the workpiece W is determined by the rotating mechanism 50, the laser torch 30 is moved to a position at which a first end of the inner peripheral surface of the workpiece W in the axial direction can be irradiated with a laser beam, by the moving mechanism 40. Subsequently, the n-th area which is located immediately below the laser torch 30 is irradiated with a laser beam while a powder of a white metal is supplied to the n-th area from the powder supply unit 33, and the powder is molten to form a bead. At the same time, the laser torch 30 is rotated clockwise in the circumferential direction of the workpiece W by the moving mechanism 40. Subsequently, the laser torch 30 is relatively moved to the base side of the workpiece W in the axial direction by the bead width, by the moving mechanism 40, and then the laser torch 30 is rotated counterclockwise in the circumferential direction of the workpiece W. By repeating these operations, the bead is formed in a rectangular wave shape without any gap in the n-th area on the inner peripheral surface of the workpiece W. By forming the moving mechanism 40 as a robot arm, it is possible to support both operations including movement of the laser torch 30 in the axial direction and rotation of the laser torch 30 around a central axis thereof.

When forming of the bead in the n-th area is completed, the variable n is increased by 1 in S7, and S3 to S7 are repeatedly performed until n reaches N, whereby a laser clad layer of a white metal is formed on the entire inner peripheral surface of the workpiece W. According to this modified example, similarly to the above-mentioned embodiment, it is possible to efficiently form a laser clad layer on the entire inner peripheral surface of the workpiece W while preventing sagging of beads.

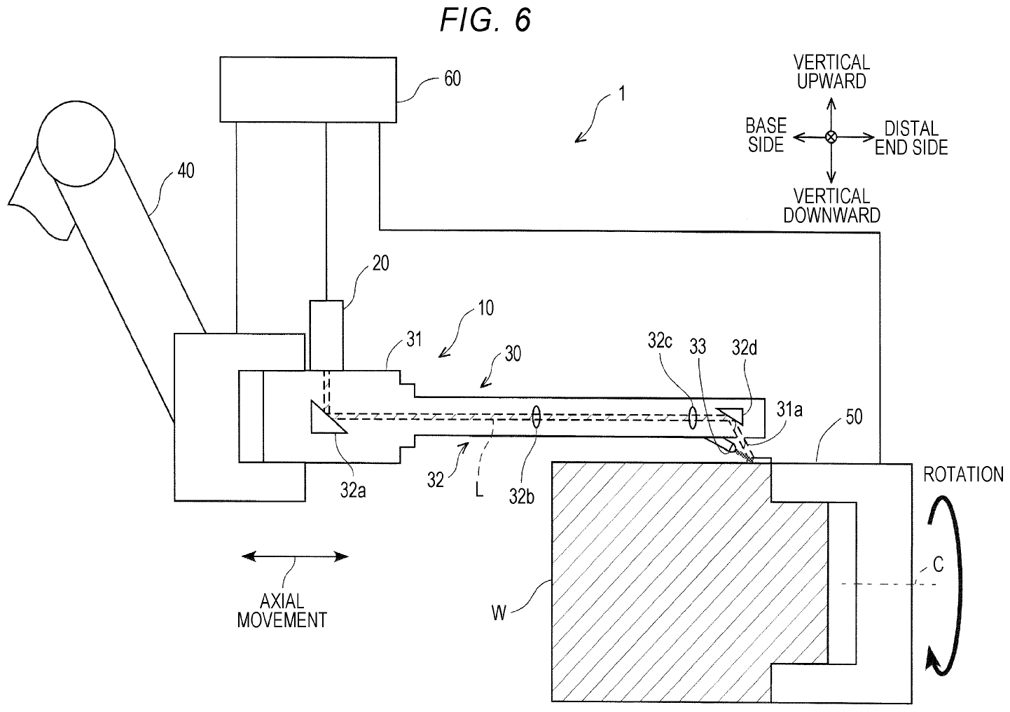

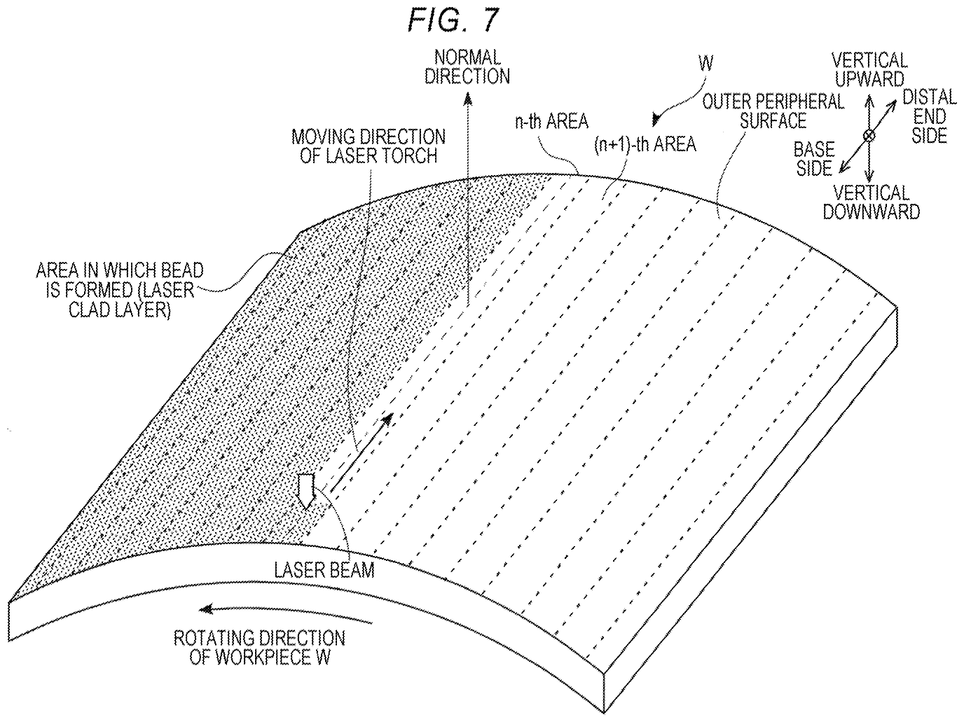

A second embodiment of the disclosure will be described below with reference to FIGS. 6 and 7. FIG. 6 is an entire configuration diagram illustrating a configuration of a laser cladding device 1 and a positional relationship with a workpiece W according to the second embodiment. FIG. 7 is a perspective view schematically illustrating an example in which beads are formed on an outer peripheral surface of a workpiece W according to the second embodiment.

In the first embodiment, the laser clad layer is formed on the inner peripheral surface of the workpiece W, but the second embodiment is different from the first embodiment in that the laser clad layer is formed on an outer peripheral surface of a workpiece W. That is, the configuration of the laser cladding device 1 is the same as that in the first embodiment and the positional relationship between the laser torch 30 and the workpiece W is different from that in the first embodiment. Specifically, in the first embodiment, the laser torch 30 is inserted and disposed in a space defined by the inner periphery of the workpiece W such that the exit port 31a faces the inner peripheral surface. However, in the second embodiment, the laser torch 30 is disposed vertically above the workpiece W and the exit port 31a faces the outer peripheral surface of the workpiece W as illustrated in FIG. 6. The flow of processes in the laser clad layer forming method is the same as that in the first embodiment. The same details as in the first embodiment will not be described, the same elements will be referred to by the same reference signs, and detailed description thereof will not be repeated.

In the partitioning process S1, a formation-scheduled portion for a laser clad layer on the outer peripheral surface of the workpiece W is partitioned into N areas (where N is a positive integer) in the circumferential direction such that each of N areas corresponds to a bead width of a white metal. In FIG. 6, boundaries between neighboring areas are illustrated by dashed lines.

In the phase determining process S3, the workpiece W is held such that the axial direction thereof is horizontal by the rotating mechanism 50 and the phase is determined by rotating the workpiece W such that the direction of the normal to the outer peripheral surface of the workpiece W at the center, in the circumferential direction, of the n-th area (where n is an integer in a range of 1 to N) in which a bead is not formed among the N areas is the vertical upward direction. In this state in which the phase of the n-th area is determined, the center of the n-th area in the circumferential direction is located on the uppermost side in the vertical direction on the outer peripheral surface of the workpiece W. That is, in each phase determining process S3, the workpiece W is rotated by an angle corresponding to the length of each area in the circumferential direction and the phase is determined such that the n-th area in which the bead is to be formed is located on the uppermost side in the vertical direction.

In the forming process S4, in a state in which the phase of the workpiece W is determined by the rotating mechanism 50, the laser torch 30 is moved to a position at which a first end of the workpiece W in the axial direction can be irradiated with a laser beam, by the moving mechanism 40. Subsequently, the n-th area which is located immediately below the laser torch 30 is irradiated with a laser beam while a powder of a white metal is supplied to the n-th area from the powder supply unit 33, and the powder is molten to form the bead. At the same time, the laser torch 30 is relatively moved to a second end of the workpiece W in the axial direction by the moving mechanism 40. Accordingly, the bead of a white metal extending in an axially straight shape is formed in the n-th area on the outer peripheral surface of the workpiece W.

In this embodiment, the same advantages as in the first embodiment can be achieved. That is, by repeating the phase determining process S3 of disposing the laser torch 30 above the outer peripheral surface of the workpiece W in the vertical direction and determining the phase such that one area on the outer peripheral surface of the workpiece W is located on the uppermost side in the vertical direction and is in a substantially horizontal state and the forming process S4 of irradiating a powder of a white metal in the one area with a laser beam to form the bead, it is possible to efficiently form a laser clad layer on the entire outer peripheral surface of the workpiece W while preventing sagging of beads.

The disclosure is not limited to the above-mentioned embodiments and can be modified in various forms without departing from the scope of the disclosure. In the above-mentioned embodiments, an example of the workpiece W is a bearing metal that supports a shaft of a grinding machine or the like such that the shaft is rotatable, but the disclosure is not limited thereto. The disclosure may be applied to a bearing metal of a supporting part of a plain bearing (i.e., sliding bearing) in an engine of a vessel or a vehicle, a turbine, a power generator, or the like. In brief, the laser clad layer forming method according to the disclosure can be applied to machining of any workpiece having a peripheral surface around a central axis thereof. An example in which a laser clad layer is made of a white metal as a metal with a melting point of 500° C. or lower is described above, but a tin-based alloy other than a white metal may be used or a metal with a melting point of 500° C. or lower other than a tin-based alloy may be used.

A laser clad layer is formed on an inner peripheral surface of a cylindrical workpiece W in the first embodiment and on an outer peripheral surface of a columnar workpiece W in the second embodiment, but the shape of the workpiece W or the peripheral surface on which the laser clad layer is formed are not limited thereto. A laser clad layer may be formed on a polygonal inner peripheral surface of a tubular workpiece or a laser clad layer may be formed on an outer peripheral surface of a polygonal columnar workpiece. In brief, a laser clad layer can be formed on a peripheral surface of a workpiece around a central axis thereof.

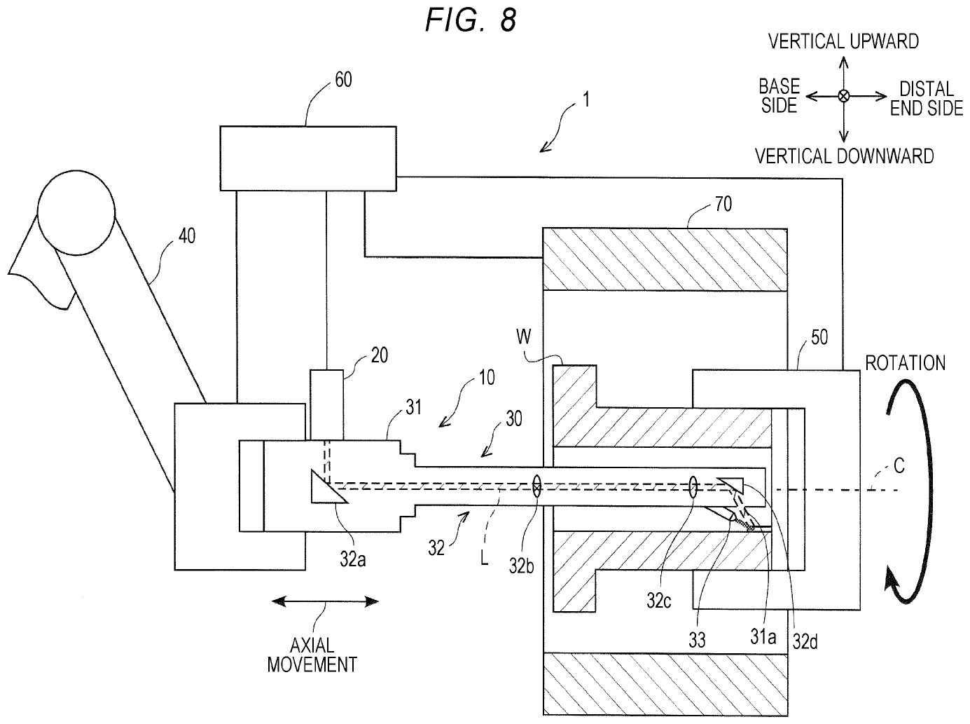

In the above-mentioned embodiments, a workpiece W in which beads of a white metal are formed on the peripheral surface is cooled at the ordinary temperature, but a reheating process of reheating the workpiece W at a predetermined temperature (for example, about 170° C.) using a heating device such as a heating pool or a heater may be provided after the forming process S4 has been performed. For example, as illustrated in FIG. 8, a whole workpiece W may be set in a temperature-controlled housing 70 which can heat and cool an object and the control unit 60 may perform a reheating process by controlling the temperature-controlled housing 70 after the forming process S4 has been performed. According to this modified example, since beads are slowly cooled over time in the reheating process to form the tissue thereof, it is possible to form a laser clad layer with more uniform and higher quality.

In the above-mentioned embodiments, the cooling process S6 is performed after the phase determining process S3 and the forming process S4 have been repeated a plurality of times, but the cooling process S6 may be omitted as long as beads are solidified such that sagging of the beads does not occur even when the workpiece W is inclined.

The forming process S4 is performed at the ordinary temperature, but the forming process S4 may be performed in a state in which the workpiece W is constantly cooled at a temperature lower than the ordinary temperature by a cooling device such as a cooling pool or a cool air blower. For example, as illustrated in FIG. 8, the whole workpiece W may be put in a temperature-controlled housing 70 which can heat and cool an object and may be constantly cooled under the control of the control unit 60. According to this modified example, since the molten white metal is rapidly solidified due to cooling of the workpiece W, it is possible to more effectively prevent sagging of beads. In this modified example, the cooling process S6 may be omitted as long as the beads are solidified to such an extent that sagging of the beads does not occur.

In the above-mentioned embodiments, the output power of a laser beam may be variable in the forming process S4, instead of making the output power of a laser beam constant. For example, by capturing an image of a molten pool of a metal which is formed with irradiation with a laser beam using a camera and performing control for decreasing the output power of the laser beam from the laser oscillator 20 using the control unit 60 when it is detected based on the captured image that the size of the molten pool is equal to or greater than a predetermined value, it is possible to more effectively prevent sagging of beads.

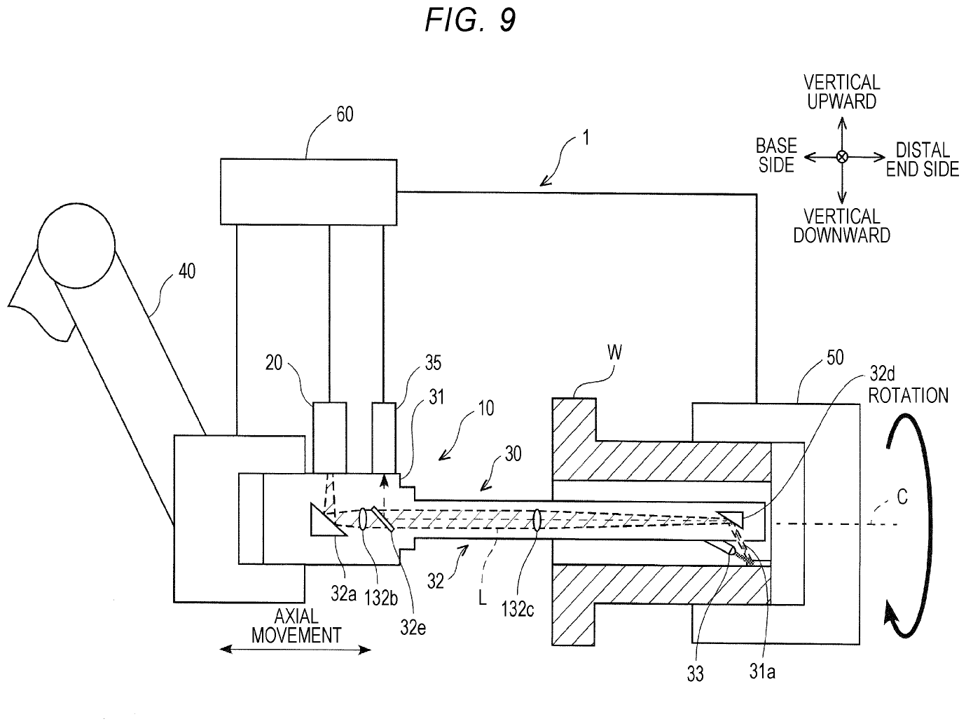

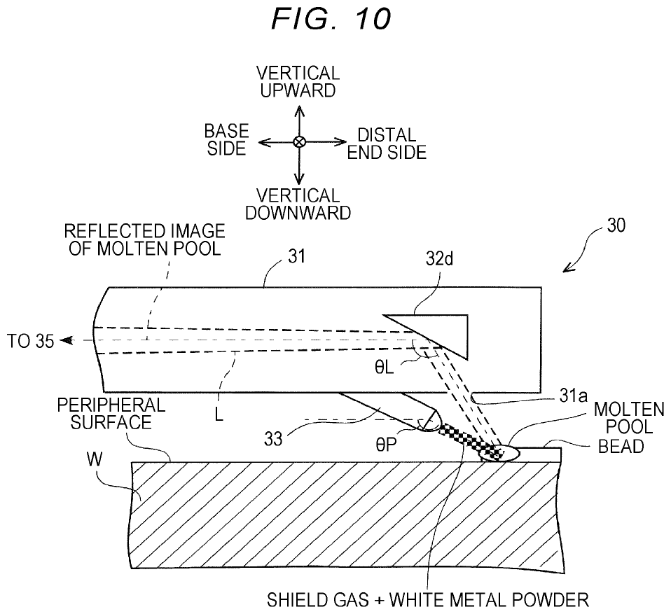

Hereinafter, laser clad layer forming methods and laser cladding devices according to other embodiments of the disclosure will be described with reference to the accompanying drawings. A configuration of a laser cladding device 1 according to a third embodiment will be described below with reference to FIG. 9. FIG. 9 is an entire configuration diagram illustrating a configuration of the laser cladding device 1 and a positional relationship with a workpiece W according to the third embodiment. FIG. 10 is an enlarged side view of a distal end of a laser torch 30 of the laser cladding device 1.

The laser cladding device 1 is a device that forms a laser clad layer of a metal with a melting point of 500° C. or lower on a peripheral surface of a workpiece W. In this embodiment, it is assumed that a laser clad layer is made of a tin-based metal as the metal with a melting point of 500° C. or lower. Examples of the tin-based metal include tin (Sn) and tin alloys containing tin as a major component. Examples of the tin alloy include alloys containing metals such as copper (Cu), lead (Pb), zinc (Zn), silver (Ag), and bismuth along with tin, as components. In this embodiment, it is assumed that a white metal is used as an example of the tin-based metal. The white metal is a tin-based alloy described in JIS5401 and is an alloy containing antimony, copper, or the like with tin as a major component. The workpiece W is a cylindrical member including an inner peripheral surface and an outer peripheral surface. In this embodiment, an example of the workpiece W is a bearing metal that is made of an iron-based metal material such as a chromium-molybdenum steel (SCM steel) and supports a shaft of a grinding machine or the like such that the shaft is rotatable. Here, the workpiece W is not limited to a bearing metal.

As illustrated in FIG. 9, the laser cladding device 1 includes a laser beam irradiation mechanism 10, a rotating mechanism 50, and a control unit 60. The laser beam irradiation mechanism 10 includes a laser oscillator 20, a laser torch 30, and a moving mechanism 40.

The laser oscillator 20 is attached to an outer peripheral surface of a base side of the laser torch 30 and emits a laser beam L inward in a radial direction of the laser torch 30. The laser oscillator 20 can vary an output power of the laser beam. Specifically, as will be described later in detail, the control unit 60 varies the output power of a laser beam by controlling the laser oscillator 20 based on image data on a molten pool which is sent from an imaging unit 35. The laser torch 30 includes a cylindrical body 31, an optical system 32 that is disposed inside the body 31, a powder supply unit 33, and an imaging unit 35. An exit port 31a is formed on a lower side surface in the vicinity of a distal end of the body 31. The laser oscillator 20 and the laser torch 30 constitute a laser irradiation unit in the claims.

The optical system 32 includes a first reflecting portion 32a, a collimation lens 132b, a focusing lens 132c, a second reflecting portion 32d, and a half mirror 32e. The first reflecting portion 32a is disposed inside the base side of the laser torch 30 and reflects a laser beam L emitted from the laser oscillator 20 in a radial direction toward the distal end in the axial direction. The collimation lens 132b is a convex lens and serves to convert a laser beam L, which is reflected by the first reflecting portion 32a and is diffused and incident on the collimation lens 132b, into a parallel beam and to guide the parallel beam to the focusing lens 132c. The focusing lens 132c is a convex lens, and serves to focus the laser beam L converted into the parallel beam by the collimation lens 132b, to convert the laser beam L into a convergent beam, and guide the convergent beam to the second reflecting portion 32d. A plurality of collimation lenses 132b and a plurality of focusing lenses 132c may be provided.

The second reflecting portion 32d is disposed inside the vicinity of the distal end of the body 31 facing the exit port 31a and reflects the laser beam L, which is focused by the collimation lens 132b and the focusing lens 132c, obliquely downward. For example, as illustrated in FIG. 10, the laser beam L which is incident on the second reflecting portion 32d is reflected downward at an angle θL with respect to the axial direction of the body 31 and is applied to a workpiece W via the exit port 31a. The angle θL may be set to, for example, 120°. The second reflecting portion 32d sends a reflected image of an area, which is irradiated with the laser beam L via the exit port 31a on the peripheral surface of the workpiece W, in a coaxial direction which is opposite to the traveling direction of the laser beam L. The half mirror 32e is disposed on an optical axis of the laser beam L between the collimation lens 132b and the focusing lens 132c, and serves to transmit a laser beam L traveling from the first reflecting portion 32a to the second reflecting portion 32d and to reflect the reflected image of the area which is irradiated with the laser beam L on the peripheral surface of the workpiece W, toward the imaging unit 35, after the reflected image is sent by the second reflecting portion 32d via the focusing lens 132c.

The powder supply unit 33 is disposed in the vicinity of a base side of the exit port 31a and supplies a powder of a white metal to a laser-beam irradiation surface of the workpiece W with blowing of an inert shield gas. For example, as illustrated in FIG. 10, the powder supply unit 33 supplies a powder of a white metal downward at an angle θP with respect to the axial direction of the body 31. The angle θP may be set to, for example, 150°.

The imaging unit 35 includes a camera including an imaging device such as a known charge-coupled device (CCD) sensor or a complementary metal-oxide semiconductor (CMOS) image sensor. The imaging unit 35 is disposed on a side surface of the body 31, which is close to the base end, and faces the half mirror 32e. The imaging unit 35 serves to capture a reflected image that is reflected by the half mirror 32e. The reflected image is an image of an area which is irradiated with a laser beam L on the peripheral surface of the workpiece W. The imaging unit 35 sends the image data to the control unit 60. Accordingly, when a molten pool of a metal (a white metal) is formed due to irradiation with a laser beam L, the reflected image of the molten pool, which is sent via the second reflecting portion 32d, the focusing lens 132c, and the half mirror 32e, is captured by the imaging unit 35 and image data on the molten pool is sent to the control unit 60.

The moving mechanism 40 is a mechanism that moves the laser torch 30 and the workpiece W relative to each other in the axial direction. The moving mechanism 40 may be a known mechanism that can hold and horizontally move the laser torch 30 in the axial direction, for example, a robot arm.

The rotating mechanism 50 is a mechanism that holds the workpiece W such that the axial direction thereof is horizontal and rotates the workpiece W around a central axis C. The rotating mechanism 50 includes, for example, a chuck that holds an axial end of the workpiece W and a servomotor that rotates the chuck around the central axis C.

The control unit 60 is a computer including a CPU, a ROM, and a RAM which are not illustrated, and performs processes of a laser clad layer forming method by controlling the operations of the units of the laser beam irradiation mechanism 10 and the rotating mechanism 50. The control unit 60 recognizes the size of the molten pool which is formed due to irradiation of the workpiece W with a laser beam, by performing a known image recognition process on the image data which is sent from the imaging unit 35.

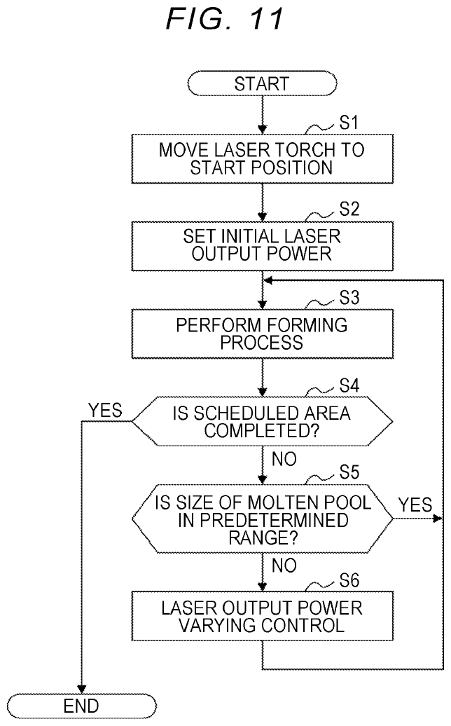

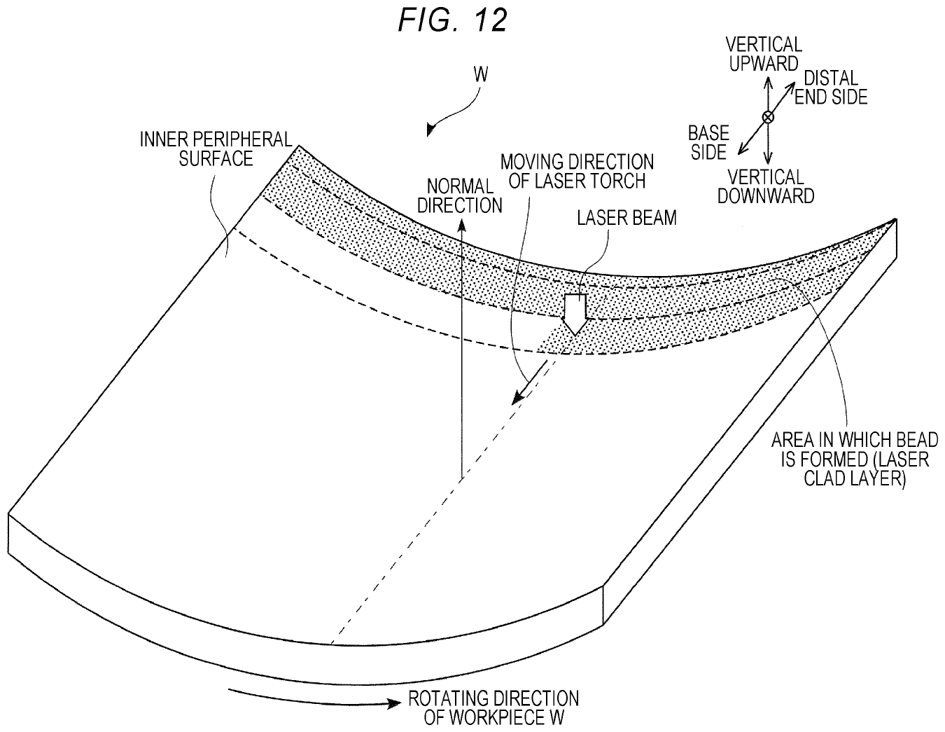

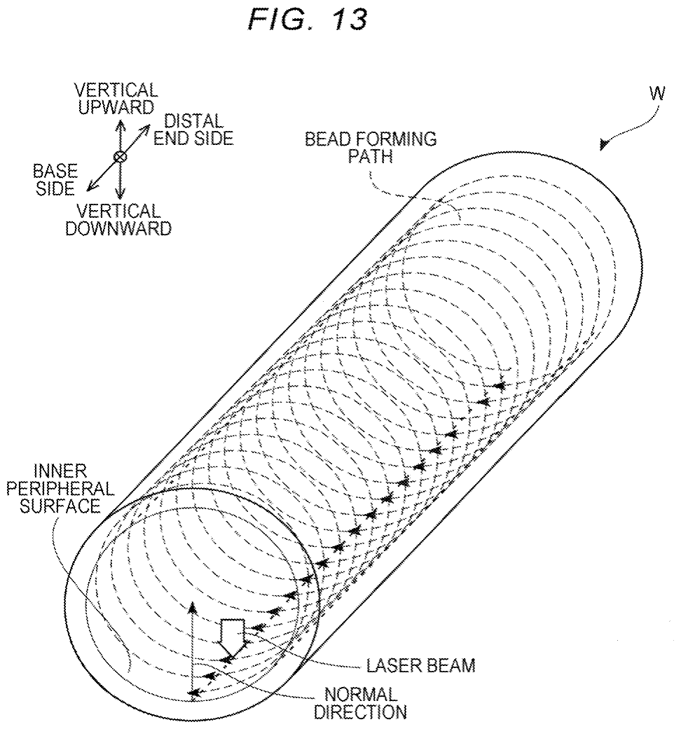

The laser clad layer forming method using the laser cladding device 1 will be described below with reference to FIGS. 11 to 13. FIG. 11 is a flowchart illustrating the flow of the laser clad layer forming method. FIG. 12 is a perspective view schematically illustrating an example in which the laser clad layer forming method is performed on the inner peripheral surface of the workpiece W and illustrating a part of the workpiece W. FIG. 13 is a perspective view illustrating a bead forming path on the inner peripheral surface of the workpiece W.

The laser clad layer forming method according to this embodiment is a method of irradiating the inner peripheral surface of the workpiece W around the central axis C with a laser beam while supplying a powder of a white metal which is a metal with a melting point of 500° C. or lower via the laser torch 30 and forming a laser clad layer of the white metal on the inner peripheral surface of the workpiece W by melting the powder. The laser clad layer forming method is performed by the control unit 60. The laser torch 30 is inserted into a space which is defined by an inner periphery of the workpiece W from the base side, and is held horizontally such that the exit port 31a faces directly downward, by the moving mechanism 40.

First, as illustrated in the flowchart of FIG. 11, the laser torch 30 is moved to a start position in Step 1 (Step 1 is hereinafter abbreviated to S1. The same applies to the other steps). For example, when beads are formed from a first end (a distal end) to a second end (a base) of a workpiece W, the start position is set to a position at which the exit port 31a of the laser torch 30 faces the vicinity of the first end (the distal end) of the inner peripheral surface of the workpiece W.

Then, in S2, the laser output power of the laser oscillator 20 is initially set to a predetermined reference value. Subsequently, in S3, a forming process is performed. Specifically, an area which is located immediately below the laser torch 30 on the inner peripheral surface of the workpiece W is irradiated with a laser beam while a powder of a white metal is supplied to the area from the powder supply unit 33, and the powder is molten to form a bead. Specifically, a powder is molten to form the bead by forming a molten pool in the workpiece W irradiated with a laser beam and supplying the powder to the molten pool or by irradiating the powder with a laser beam. At the same time, the workpiece W is rotated counterclockwise at a constant speed by holding the workpiece W such that the axial direction thereof is horizontal using the rotating mechanism 50 while the laser torch 30 is relatively moved toward the second end in the axial direction of the workpiece W at a constant speed by the moving mechanism 40. The workpiece W is held such that the axial direction thereof is horizontal by the rotating mechanism 50, and a molten pool of a metal is formed by the laser beam L which is applied via the exit port 31a at a lowermost position at which the direction of the normal to the inner peripheral surface of the workpiece W is the vertical upward direction. Accordingly, the bead is formed in a spiral shape on the inner peripheral surface of the workpiece W along the path indicated by a dashed line and arrows in FIG. 13. The forming process S3 is repeatedly performed until forming of the bead in a scheduled area is completed.

Then, in S4, it is determined whether forming of the bead in a formation-scheduled area of a laser clad layer on the inner peripheral surface of the workpiece W has been completed. For example, based on a total amount of movement of the laser torch 30 in the axial direction caused by the moving mechanism 40 from the forming start position or a total amount of rotation of the workpiece W caused by the rotating mechanism 50, it can be determined whether forming of the bead in the entire formation-scheduled portion has been completed.

When forming of the bead in the scheduled area has not been completed (S4: NO), it is determined in S5 whether the size of the molten pool is within a predetermined range based on an image captured by the imaging unit 35. Here, the “predetermined range” is the size of the molten pool in a range in which sagging of the bead does not occur and may be specifically an area of the molten pool or may be a diameter instead of an area. When the size of the molten pool is within the predetermined range (S5: YES), the flow returns to S3 and the forming process S3 is continuously performed.

When the size of the molten pool is not within the predetermined range (S5: NO), laser output power varying control is performed in S6. Specifically, when the size of the molten pool is greater than the predetermined range, the laser output power of the laser oscillator 20 is decreased by a predetermined value. On the other hand, when the size of the molten pool is smaller than the predetermined range, the laser output power of the laser oscillator 20 is increased by a predetermined value. After the laser output power varying control is performed in S6, the flow returns to S3 and the forming process S3 is continuously performed. When it is determined in S4 that forming of the bead in the scheduled area has been completed (S4: YES), the whole processes end. The processes S5 to S6 correspond to a “control process of controlling the size of the molten pool which is formed due to irradiation of the workpiece W with a laser beam during the forming process” in the disclosure, and the process S5 corresponds to a “detection process of detecting the size of the molten pool.”

As described above, the molten pool of a metal with a melting point of 500° C. or lower is gradually enlarged and sagging of the bead is likely to occur. However, with the laser cladding device 1 according to this embodiment, it is possible to reliably perform the laser clad layer forming method that makes it possible to continuously form a laser clad layer while preventing sagging of the bead due to enlargement of the molten pool, by forming the bead while controlling the size of the molten pool which is formed due to irradiation with a laser beam.

In this embodiment, the control process of S5 and S6 includes adjusting control parameters in the forming process S3 such that the size of the molten pool is within the predetermined range. Accordingly, since the size of the molten pool is maintained within the predetermined range in which sagging of the bead does not occur, it is possible to reliably prevent sagging of the bead. Specifically, in the control process of S5 and S6, it is possible to reliably control the size of the molten pool by varying the output power of a laser beam in the laser oscillator 20 during the forming process S3. Particularly, the process of S5 is performed as the detection process of detecting the size of the molten pool based on image data from the imaging unit 35 and the size of the molten pool is controlled by varying the laser output power in S6 based on the result of detection. Therefore, it is possible to effectively prevent sagging of the bead by performing control in accordance with a current state of the molten pool.

Particularly, in this embodiment, by inserting and disposing the laser torch 30 in a space defined by the inner periphery of the workpiece W and repeating determination of a phase based on rotation of the workpiece W and movement of the laser torch 30 in the axial direction, it is possible to efficiently form a laser clad layer on the entire inner peripheral surface of the workpiece W while preventing sagging of the bead.

The workpiece W is a cylindrical member, a formation-scheduled portion of a laser clad layer is set on the inner peripheral surface thereof. In the forming process S3, the workpiece W is held such that the axial direction thereof is horizontal, and the workpiece W is rotated such that a forming-scheduled position for the bead (i.e., a position at which the bead is to be formed) on the inner peripheral surface of the workpiece W is at a lowermost position at which the direction of the normal to the forming-scheduled position for the bead is the vertical upward direction. At the same time, a powder of a white metal is irradiated with a laser beam while the workpiece W and the laser torch 30 are moved relative to each other in the axial direction and the powder is supplied to the workpiece. Thus, the powder is molten to form the bead in a spiral shape on the inner peripheral surface of the workpiece W. Accordingly, it is possible to continuously form the bead on the inner peripheral surface of the workpiece W while preventing sagging of the bead by controlling the size of the molten pool. Thus, it is possible to efficiently form a laser clad layer.

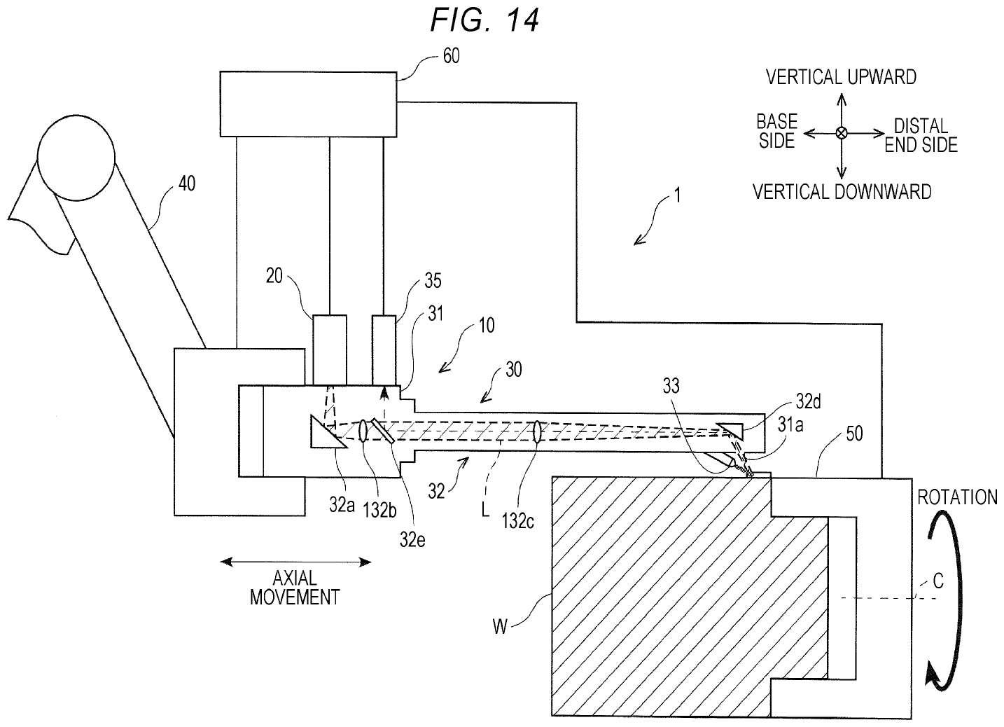

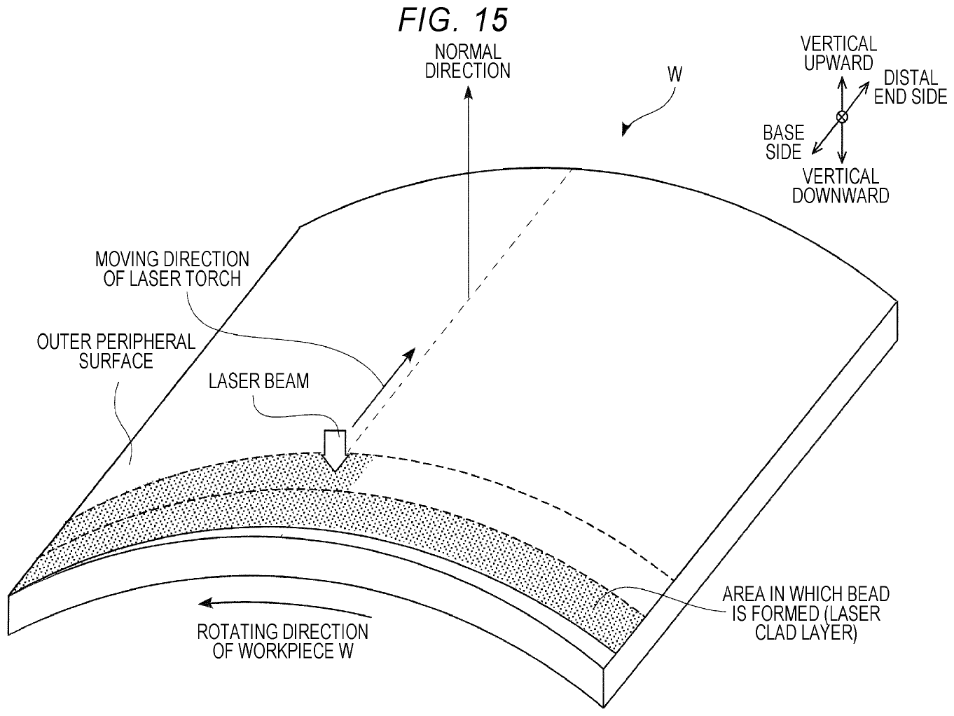

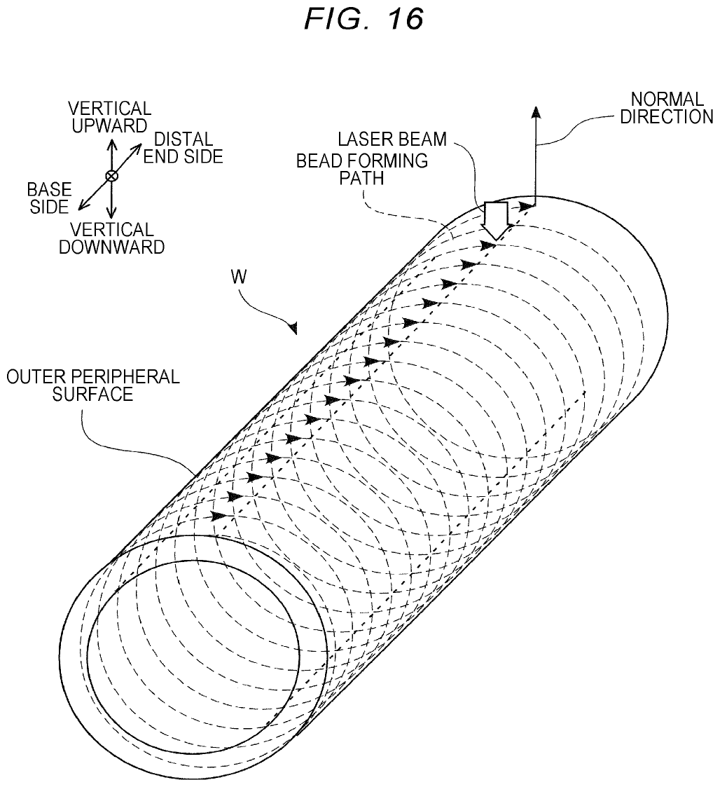

A fourth embodiment of the disclosure will be described below with reference to FIGS. 14 to 16. FIG. 14 is an entire configuration diagram illustrating a configuration of a laser cladding device 1 and a positional relationship with a workpiece W according to the fourth embodiment. FIG. 15 is a perspective view schematically illustrating an example in which a bead is formed on an outer peripheral surface of a workpiece W according to the fourth embodiment. FIG. 16 is a perspective view illustrating a bead forming path on the outer peripheral surface of the workpiece W according to the fourth embodiment.

In the third embodiment, the laser clad layer is formed on the inner peripheral surface of the workpiece W. However, the fourth embodiment is different from the third embodiment in that the laser clad layer is formed on an outer peripheral surface of a workpiece W. That is, the configuration of the laser cladding device 1 is the same as that in the third embodiment and the positional relationship between the laser torch 30 and the workpiece W is different from that in the third embodiment. Specifically, in the third embodiment, the laser torch 30 is inserted and disposed into a space defined by the inner periphery of the workpiece W such that the exit port 31a faces the inner peripheral surface. However, in the fourth embodiment, the laser torch 30 is disposed vertically above the workpiece W and the exit port 31a faces the outer peripheral surface of the workpiece W as illustrated in FIG. 14. The flow of processes in the laser clad layer forming method is the same as that in the third embodiment. The same details as in the third embodiment will not be described, the same elements will be referred to by the same reference signs, and detailed description thereof will not be repeated.

As illustrated in the flowchart of FIG. 11, the laser torch 30 is moved to a start position in S1. For example, in this embodiment, when the bead is formed from a first end (a distal end) to a second end (a base) of a workpiece W, the start position is set to a position at which the exit port 31a of the laser torch 30 faces the vicinity of the first end (the distal end) of the outer peripheral surface of the workpiece W.

Then, in S2, the laser output power of the laser oscillator 20 is initially set to a predetermined reference value. Subsequently, in S3, a forming process is performed. Specifically, an area which is located immediately below the laser torch 30 on the outer peripheral surface of the workpiece W is irradiated with a laser beam while a powder of a white metal is supplied to the area from the powder supply unit 33, and the powder is molten to form the bead. At the same time, the workpiece W is rotated counterclockwise at a constant speed by holding the workpiece W such that the axial direction thereof is horizontal using the rotating mechanism 50 while the laser torch 30 is relatively moved toward the second end of the workpiece W in the axial direction at a constant speed by the moving mechanism 40. The workpiece W is held such that the axial direction thereof is horizontal by the rotating mechanism 50, and a molten pool of a metal is constantly formed by the laser beam L which is applied via the exit port 31a at an uppermost position at which the direction of the normal to the outer peripheral surface of the workpiece W is the vertical upward direction. Accordingly, the bead is formed on the outer peripheral surface of the workpiece W along the path indicated by a dashed line and arrows in FIG. 16.

Then, in S4, it is determined whether forming of the bead in the formation-scheduled portion for a laser clad layer (i.e., a portion on which a laser clad layer is to be formed) on the outer peripheral surface of the workpiece W has been completed. For example, based on a total amount of movement of the laser torch 30 in the axial direction caused by the moving mechanism 40 from the forming start position or a total amount of rotation of the workpiece W caused by the rotating mechanism 50, it can be determined whether forming of the bead in the entire formation-scheduled portion has been completed.

When forming of the bead in the scheduled area has not been completed (S4: NO), it is determined in S5 whether the size of the molten pool is within a predetermined range based on an image captured by the imaging unit 35. When the size of the molten pool is within the predetermined range (S5: YES), the flow returns to S3 and the forming process S3 is continuously performed.

When the size of the molten pool is not within the predetermined range (S5: NO), laser output power varying control is performed in S6. Specifically, when the size of the molten pool is greater than the predetermined range, the laser output power of the laser oscillator 20 is decreased by a predetermined value. On the other hand, when the size of the molten pool is smaller than the predetermined range, the laser output power of the laser oscillator 20 is increased by a predetermined value. After the laser output power varying control is performed in S6, the flow returns to S3 and the forming process S3 is continuously performed. When it is determined in S4 that forming of the bead in the scheduled area has been completed (S4: YES), the whole processes end.

In this embodiment, the workpiece W is a cylindrical or columnar member, a formation-scheduled portion for a laser clad layer is set on the outer peripheral surface thereof, and the forming process S3 is performed in a state in which the workpiece W is held such that the axial direction thereof is horizontal and the phase of the workpiece W is determined such that the forming-scheduled position of the bead is located on the uppermost side in the vertical direction on the outer peripheral surface. The same advantages as in the third embodiment are achieved in this embodiment. That is, by disposing the laser torch 30 above the outer peripheral surface of the workpiece W in the vertical direction and forming the bead while controlling the size of a molten pool which is formed due to irradiation with a laser beam, it is possible to continuously form a laser clad layer while preventing sagging of the bead.

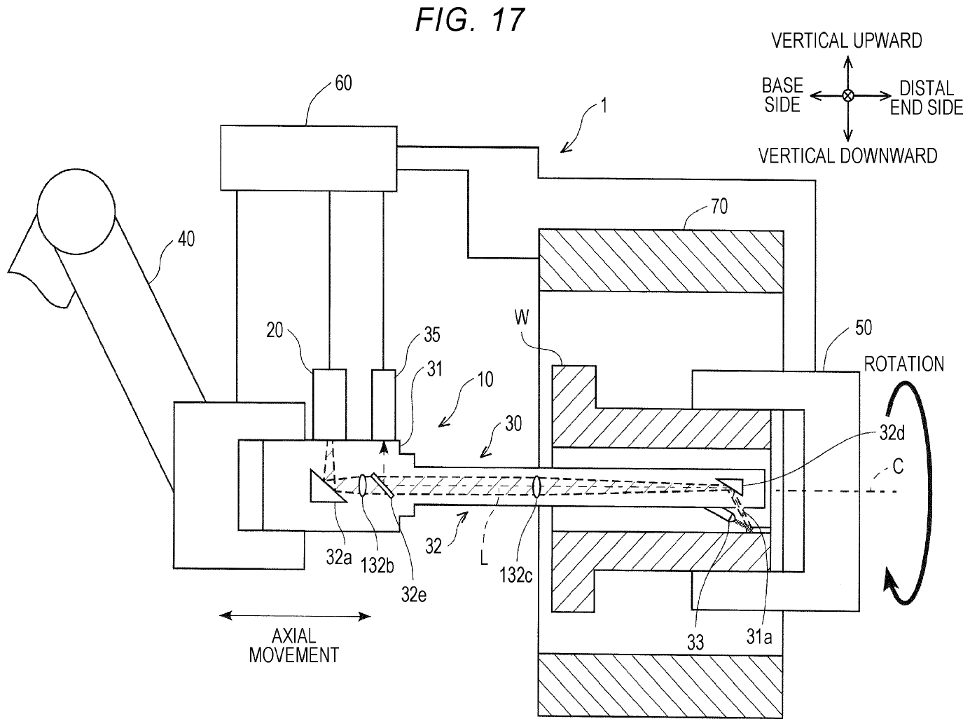

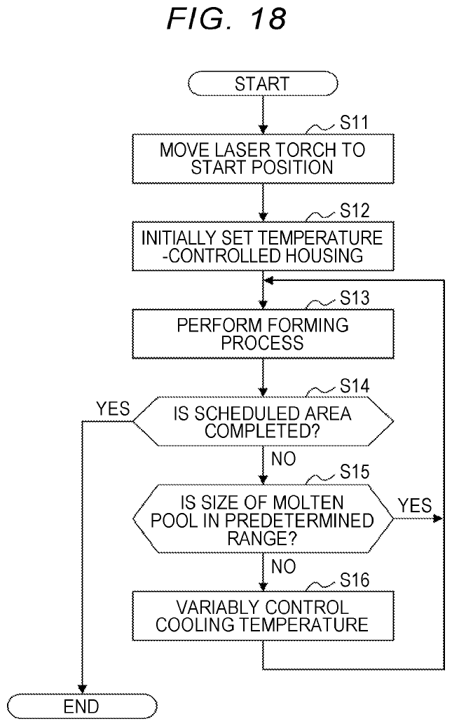

A fifth embodiment of the disclosure will be described below with reference to FIGS. 17 and 18. FIG. 17 is an enlarged view illustrating a distal end of a laser torch 30 according to the fifth embodiment. In the above-mentioned embodiments, a laser output power which is a control parameter in forming of the bead is varied to control the size of the molten pool of a white metal. However, in this embodiment, a cooling power for a workpiece W which is another control parameter is set to be variable.

In this embodiment, as illustrated in FIG. 17, in addition to the elements in the third embodiment, a temperature-controlled housing 70 that can heat and cool an object is provided and a whole workpiece W is put into the temperature-controlled housing 70. The temperature-controlled housing 70 can vary the cooling power for the workpiece W.

First, as illustrated in the flowchart of FIG. 18, the laser torch 30 is moved to a start position in S11. Then, in S12, initial setting of the temperature-controlled housing 70 is performed, that is, the cooling power is initially set to a predetermined reference value. Subsequently, in S13, a forming process is performed. Then, in S14, it is determined whether forming of the bead in a formation-scheduled area for a laser clad layer on the inner peripheral surface of the workpiece W has been completed. When forming of the bead in the scheduled area has not been completed (S14: NO), it is determined in S15 whether the size of a molten pool is within a predetermined range based on an image captured by the imaging unit 35. When the size of the molten pool is within the predetermined range (S15: YES), the flow returns to S13 and the forming process S13 is continuously performed.

When the size of the molten pool is not within the predetermined range (S15: NO), cooling power varying control for the temperature-controlled housing 70 is performed in S16. Specifically, when the size of the molten pool is greater than the predetermined range, the cooling power of the temperature-controlled housing 70 is increased by a predetermined value. Accordingly, the temperature of the workpiece W is decreased and the size of the molten pool is gradually decreased. On the other hand, when the size of the molten pool is smaller than the predetermined range, the cooling power of the temperature-controlled housing 70 is decreased by a predetermined value. Accordingly, the temperature of the workpiece W is increased and the size of the molten pool is gradually increased. After the cooling power varying control has been performed in S16, the flow returns to S13 and the forming process S13 is continuously performed. When it is determined in S14 that forming of the bead in the scheduled area has been completed (S14: YES), the whole processes end. The processes of S15 to S16 correspond to the control process in the disclosure, and the process S15 corresponds to the detection process.

According to this embodiment, in the control process of S15 and S16, the size of the molten pool is controlled by varying the cooling power for the workpiece W using the temperature-controlled housing 70 during the forming process S13. Accordingly, in this embodiment, similarly to the first embodiment, it is possible to continuously form a laser clad layer while preventing sagging of the bead by forming the bead while controlling the size of the molten pool which is formed due to irradiation with a laser beam.

The disclosure is not limited to the above-mentioned embodiments and can be modified in various forms without departing from the scope of the disclosure. In the third to fifth embodiments, an example of the workpiece W is a bearing metal that supports a shaft of a grinding machine or the like such that the shaft is rotatable, but the disclosure is not limited thereto. The disclosure may be applied to a bearing metal of a supporting part of a plain bearing (i.e., a sliding bearing) in an engine of a vessel, a vehicle, a turbine, a power generator, or the like. In brief, the laser clad layer forming method according to the disclosure can be applied to machining of any workpiece having a peripheral surface around a central axis thereof. An example in which a laser clad layer is made of a white metal as a metal with a melting point of 500° C. or lower is described above. However, a tin-based alloy other than a white metal may be used, or a metal with a melting point of 500° C. or lower other than a tin-based alloy may be used.

A laser clad layer is formed on an inner peripheral surface of a cylindrical workpiece W in the third embodiment and on an outer peripheral surface of a columnar workpiece W in the fourth embodiment. However, the shape of the workpiece W or the peripheral surface on which the laser clad layer is formed are not limited thereto. A laser clad layer may be formed on a polygonal inner peripheral surface of a tubular workpiece or a laser clad layer may be formed on an outer peripheral surface of a polygonal columnar workpiece. In brief, a laser clad layer can be formed on a peripheral surface of a workpiece around a central axis thereof.

In the fifth embodiment, a reheating process of reheating the workpiece W using the temperature-controlled housing 70 may be provided after the forming process S13 has been performed. According to this modified example, since the bead is slowly cooled over time in the reheating process, it is possible to form a laser clad layer with more uniform and higher quality.

In the third embodiment, the bead is formed in a spiral shape on the inner peripheral surface of the workpiece W, but the disclosure is not limited thereto. For example, in the forming process S3, a process of holding the workpiece W such that the axial direction thereof is horizontal, irradiating a powder of a white metal with a laser beam while rotating the workpiece W such that the direction of the normal to the forming-scheduled position for the bead on the inner peripheral surface of the workpiece W is the vertical upward direction and supplying the powder, and melting the powder to form the bead in an annular shape on the inner peripheral surface of the workpiece W and a process of moving the workpiece W and the laser torch 30 relative to each other in the axial direction by a bead width may be repeatedly performed. According to this modified example, since annular beads are sequentially formed to be adjacent to each other in the axial direction on the inner peripheral surface of the workpiece W, a laser clad layer can be formed on the entire inner peripheral surface of the workpiece W. Similarly, in the fourth embodiment, by performing the same process as in the modified example, annular beads are sequentially formed to be adjacent to each other in the axial direction on the outer peripheral surface of the workpiece W and thus a laser clad layer can be formed on the entire outer peripheral surface of the workpiece W.

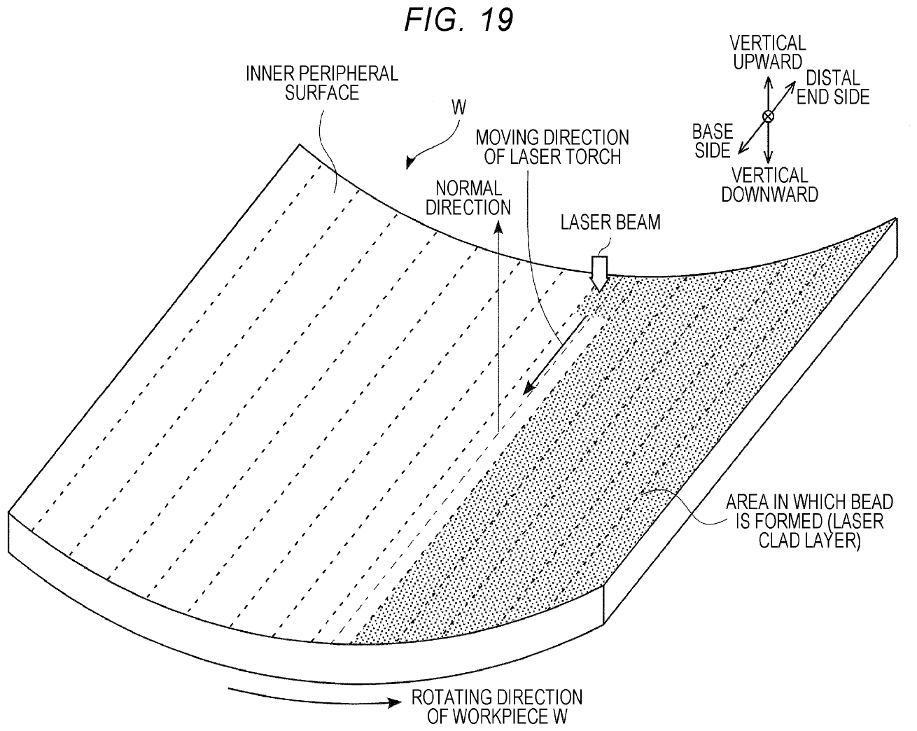

Alternatively, instead of the bead forming methods according to the embodiments or modified examples, as illustrated in FIG. 19, a laser clad layer may be formed by partitioning a formation-scheduled portion on the peripheral surface of the workpiece W into a plurality of areas each of which has an angle equal to or less than 90 degrees in the circumferential direction (a partitioning process), holding the workpiece W such that the axial direction thereof is horizontal and determining the phase of the workpiece W such that the direction of the normal to the peripheral surface of the workpiece W in one area among the plurality of areas is within a predetermined angle range with respect to the vertical upward direction (a phase determining process), moving the laser torch 30 between the distal end and the base of the workpiece W in the axial direction and forming a bead on the peripheral surface of the workpiece W (a forming process), and repeatedly performing the phase determining process and the forming process on the respective areas to form beads in the whole formation-scheduled portion on the peripheral surface of the workpiece W.

In this modified example, the process of defining the areas is performed as an internal process performed in the control unit 60 but boundaries between the neighboring areas are illustrated by dashed lines in FIG. 19 for the purpose of easy understanding. According to this modified example, since the workpiece W is not rotated during forming of beads, it is possible to curb occurrence of sagging of beads due to inclination of the workpiece W which is heated due to irradiation with a laser beam. This modified example can be applied to formation of a laser clad layer on an outer peripheral surface of a workpiece W, similarly to the fourth embodiment.

In the above-mentioned embodiments, an image of an area which is irradiated with a laser beam L is captured by the imaging unit 35 and the size of a molten pool is detected based on image data, but the disclosure is not limited thereto. For example, the temperature of the workpiece W may be measured using a temperature sensor and the size of a molten pool may be estimated and detected from the measured temperature of the workpiece W. Alternatively, when a laser cladding method is performed by setting the conditions (including the shape and size of the workpiece W, ambient temperature around the workpiece W, and the like) to the same conditions, the detection process of S5 or S15 may be omitted by setting an optimal variation pattern of the laser output power or the cooling power based on experiment or simulation in advance. According to this modified example, by varying the laser output power or the cooling power in a predetermined pattern which is set in accordance with progress of forming of beads on the peripheral surface of the workpiece W, it is possible to control the size of a molten pool and to prevent sagging of beads.

In the fifth embodiment, the workpiece W is put in the temperature-controlled housing 70 and the size of a molten pool is controlled by cooling the whole workpiece W, but only the periphery of the molten pool of the workpiece W may be cooled to control the size of the molten pool. For example, the periphery of the molten pool may be cooled by blowing cool air to the periphery.

What is claimed is:

1. A laser clad layer forming method of irradiating a powder of a metal with a melting point of 500° C. or lower with a laser beam from a laser irradiation unit while supplying the powder to a peripheral surface of a workpiece around a central axis of the workpiece and forming a laser clad layer of the metal on the peripheral surface of the workpiece using the powder that is molten, the laser clad layer forming method comprising:
a partitioning process of partitioning a formation-scheduled portion for the laser clad layer on the peripheral surface of the workpiece into a plurality of areas each of which has an angle equal to or less than 90 degrees in a circumferential direction;
a phase determining process of holding the workpiece such that an axial direction thereof is horizontal and determining a phase of the workpiece such that a direction of a normal to the peripheral surface of the workpiece in one area of the plurality of areas is within a predetermined angle range with respect to a vertical upward direction; and
a forming process of irradiating the powder with the laser beam while supplying the powder to the one area in a state in which the phase of the workpiece is determined and melting the powder to form a bead,
wherein the laser clad layer is formed by repeating the phase determining process and the forming process on the areas to form the beads in the whole formation-scheduled portion.

2. The laser clad layer forming method according to claim 1, wherein the forming process is performed a plurality of times, and a cooling process of cooling the beads is performed after the forming process is performed at least one time.

3. The laser clad layer forming method according to claim 2, wherein the cooling process is performed after the phase determining process and the forming process are performed a plurality of times.

4. The laser clad layer forming method according to claim 1,
wherein the partitioning process includes partitioning the formation-scheduled portion into the areas each of which corresponds to a bead width,
wherein the phase determining process includes determining the phase by rotating the workpiece by a phase angle corresponding to the bead width, and
wherein the forming process includes forming the bead in an axially straight shape on the peripheral surface of the workpiece by moving the workpiece and the laser irradiation unit relative to each other in the axial direction.

5. The laser clad layer forming method according to claim 1,
wherein the workpiece is a tubular member and the formation-scheduled portion is set on an inner peripheral surface thereof, and
wherein the phase determining process includes determining the phase of the workpiece such that the one area defined on the inner peripheral surface is located on a lowermost side in a vertical direction.

6. The laser clad layer forming method according to claim 1,
wherein the workpiece is a tubular or columnar member and the formation-scheduled portion is set on an outer peripheral surface thereof, and
wherein the phase determining process includes determining the phase of the workpiece such that the one area defined on the outer peripheral surface is located on an uppermost side in a vertical direction.

7. The laser clad layer forming method according to claim 1, further comprising
a reheating process of reheating the workpiece in which the beads are formed on the peripheral surface.

8. The laser clad layer forming method according to claim 1, wherein the forming process includes varying an output power of the laser beam in the laser irradiation unit.

9. The laser clad layer forming method according to claim 1, wherein the forming process includes constantly cooling the workpiece.

10. The laser clad layer forming method according to claim 1, wherein the metal is a tin-based alloy.

11. A laser cladding device comprising:
a laser irradiation unit configured to irradiate a powder of a metal with a melting point of 500° C. or lower with a laser beam while supplying the powder to a workpiece;
a rotating mechanism configured to rotate the workpiece around a central axis of the workpiece while holding the workpiece such that an axial direction thereof is horizontal;
a moving mechanism configured to move the laser irradiation unit and the workpiece relative to each other in the axial direction; and
a control unit configured to perform control for repeatedly performing i) an operation of determining a phase of the workpiece such that a direction of a normal to a peripheral surface of the workpiece in one area among a plurality of areas is within a predetermined angle range with respect to a vertical upward direction, a formation-scheduled portion for a laser clad layer on the peripheral surface of the workpiece being partitioned into the plurality of areas, and each of the plurality of areas having an angle equal to or less than 90 degrees in a circumferential direction, and ii) an operation of irradiating the powder with the laser beam while supplying the powder to the one area from the laser irradiation unit and melting the powder to form a bead in a state in which the phase of the workpiece is determined, using the laser irradiation unit and the moving mechanism.

12. A laser clad layer forming method of irradiating a powder of a metal with a melting point of 500° C. or lower with a laser beam from a laser irradiation unit while supplying the powder to a peripheral surface of a workpiece around a central axis of the workpiece and forming a laser clad layer of the metal on the peripheral surface of the workpiece using the powder that is molten, the laser clad layer forming method comprising:
a forming process of irradiating the powder with the laser beam while supplying the powder to a formation-scheduled portion for the laser clad layer on the peripheral surface of the workpiece and melting the powder to form a bead; and
a control process of controlling a size of a molten pool which is formed due to irradiation with the laser beam during the forming process.

13. The laser clad layer forming method according to claim 12, wherein the control process includes adjusting a control parameter in the forming process such that the size of the molten pool is in a predetermined range.

14. The laser clad layer forming method according to claim 13, wherein the control process includes controlling the size of the molten pool by varying an output power of the laser beam in the laser irradiation unit during the forming process.

15. The laser clad layer forming method according to claim 13, wherein the control process includes controlling the size of the molten pool by cooling at least a periphery of the molten pool during the forming process.

16. The laser clad layer forming method according to claim 15, wherein the control process includes controlling the size of the molten pool by varying a cooling power.

17. The laser clad layer forming method according to claim 12, wherein the control process includes a detection process of detecting the size of the molten pool and includes controlling the size of the molten pool based on a result of detection.

18. The laser clad layer forming method according to claim 12, wherein the forming process includes holding the workpiece such that an axial direction thereof is horizontal, rotating the workpiece such that a direction of a normal to a forming-scheduled position for the bead on the peripheral surface of the workpiece is a vertical upward direction, and at the same time, irradiating the powder with the laser beam while moving the workpiece and the laser irradiation unit relative to each other in the axial direction and supplying the powder, and melting the powder to form the bead in a spiral shape on the peripheral surface of the workpiece.

19. The laser clad layer forming method according to claim 12, wherein the forming process includes repeatedly performing a process of holding the workpiece such that an axial direction thereof is horizontal, irradiating the powder with the laser beam while rotating the workpiece such that a direction of a normal to a forming-scheduled position for the bead on the peripheral surface of the workpiece is a vertical upward direction and supplying the powder, and melting the powder to form the bead in an annular shape on the peripheral surface of the workpiece, and a process of moving the workpiece and the laser irradiation unit relative to each other by a width of the bead in the axial direction.

20. The laser clad layer forming method according to claim 12, further comprising:
a partitioning process of partitioning the formation-scheduled portion on the peripheral surface of the workpiece into a plurality of areas each of which has an angle equal to or less than 90 degrees in a circumferential direction; and
a phase determining process of holding the workpiece such that an axial direction thereof is horizontal and determining a phase of the workpiece such that a direction of a normal to the peripheral surface of the workpiece in one area of the plurality of areas is within a predetermined angle range with respect to a vertical upward direction,
wherein the forming process includes irradiating the powder with the laser beam while supplying the powder to the one area and melting the powder to form the bead in a state in which the phase of the workpiece is determined, and
wherein the laser clad layer is formed by repeatedly performing the phase determining process and the forming process on the respective areas to form the beads in the entire formation-scheduled portion.

21. The laser clad layer forming method according to claim 12,
wherein the workpiece is a cylindrical member and a formation-scheduled portion for the laser clad layer is set on an inner peripheral surface thereof, and
wherein the forming process is performed in a state in which the workpiece is held such that an axial direction thereof is horizontal and a phase of the workpiece is determined such that a forming-scheduled position for the bead is located on a lowermost side in a vertical direction on the inner peripheral surface.

22. The laser clad layer forming method according to claim 12,
wherein the workpiece is a cylindrical or columnar member and the formation-scheduled portion for the laser clad layer is set on an outer peripheral surface thereof, and
wherein the forming process is performed in a state in which the workpiece is held such that an axial direction thereof is horizontal and a phase of the workpiece is determined such that a forming-scheduled position for the bead is located on an uppermost side in a vertical direction on the outer peripheral surface.

23. The laser clad layer forming method according to claim 12, further comprising a reheating process of reheating the workpiece in which the bead is formed on the peripheral surface thereof.

24. The laser clad layer forming method according to claim 12, wherein the metal is a tin-based alloy.

25. A laser cladding device comprising:
a laser torch configured to irradiate a powder of a metal with a melting point of 500° C. or lower with a laser beam while supplying the powder to a workpiece;
a moving mechanism configured to move the laser torch and the workpiece relative to each other; and
a control unit configured to irradiate a formation-scheduled portion for a laser clad layer on a peripheral surface of the workpiece around a central axis of the workpiece with the laser beam via the laser torch so as to melt the powder to form a bead, while moving the laser torch and the workpiece relative to each other via the moving mechanism and supplying the powder from the laser torch, and to control a size of a molten pool which is formed due to irradiation with the laser beam during forming of the bead.
